(19) United States
(12) Patent Application Publication
(10) Pub. No.: US 2018/0114132 A1
(43) Pub. Date: Apr. 26, 2018

(54) CONTROLLING REMOTE MEMORY ACCESSES IN A MULTIPLE PROCESSING NODE GRAPH INFERENCE ENGINE

(71) Applicant: Hewlett Packard Enterprise Development LP, Houston, TX (US)

(72) Inventors: Fei Chen, Palo Alto, CA (US); Maria Teresa Gonzalez Diaz, Mountain View, CA (US); Hideaki Kimura, Palo Alto, CA (US); Krishnamurthy Viswanathan, Mountain View, CA (US)

(21) Appl. No.: 15/568,307

(22) PCT Filed: May 29, 2015
(86) PCT No.: PCT/US2015/033319

§ 371 Date: Oct. 20, 2017

(51) Int. Cl. G06N 5/04; G06F 17/30

(52) U.S. Cl. CPC G06N 5/048; G06F 17/30958; G06T 1/60; G06F 17/30584; G06F 17/30377

(57) ABSTRACT

A technique includes performing graph inference in a graph inference engine that includes multiple processing nodes to determine assignments for vertices of a graph. Performing the graph inference includes controlling remote memory accesses within the engine, including storing first data in a local memory of the first processing node, where the first data represents at least assignments for a plurality of vertices of the graph; in the first processing node, determining updates for the assignments for a subset of the plurality of vertices of a partition of the graph assigned to the first processing node and modifying the first data based on the updates; and communicating the updates to at least one other processing node of the multiple processing nodes, where at least one other partition of the graph is assigned to the other processing node(s).

### BACKGROUND

For purposes of analyzing relatively large datasets, it may be beneficial to represent the data in the form of a graph. The graph contains vertices and edges that connect the vertices. The vertices may represent random variables, and a given edge may represent a correlation between a pair of vertices that are connected by the edge. A graph may be quite large, in that the graph may contain thousands to billions of vertices.

### BRIEF DESCRIPTION OF THE DRAWINGS

FIG. 1 is a schematic diagram of a system that performs graph inference-based processing according to an example implementation.

FIG. 2 is a schematic diagram of a multiple node graph inference engine of FIG. 1 according to an example implementation.

FIGS. 3 and 4 are flow diagrams depicting techniques to perform graph inference in a multiple processing node system according to example implementations.

FIG. 5 is an illustration of a worker communicating graph inference updates according to an example implementation.

### DETAILED DESCRIPTION

Relations between objects may be modeled using a graph. In this manner, a graph has vertices (also called “graph nodes” or “nodes”) and lines, or edges, which interconnect the vertices. A graph may be used to compactly represent the joint distribution of a set of random variables. In this manner, each vertex may represent one of the random variables, and the edges encode correlations between the random variables.

As a more specific example, the graph may be a graph of Internet, or “web,” domains, which may be used to identify malicious websites. In this manner, each vertex may be associated with a particular web domain and have an associated binary random variable. For this example, a given random variable may be assigned either a “1” (for a malicious domain) or a “0” for a domain that is not malicious. Although some of the web domains may be directly observed and thus, may be known to be malicious or non-malicious domains, such direct observations may not be available for a large number of the domains that are associated with the graph. For purposes of inferring properties of a graph, such as the above-described example graph, a process called “graph inference” may be used.

In general, graph inference involves estimating a joint distribution of random variables when direct sampling of the joint distribution cannot be performed or where such direct sampling is difficult. Graph inference may be performed using a graph inference algorithm, which estimates random variable assignments based on the conditional distributions of the random variables. In this context, a “random variable assignment” or “assignment” refers to a value that is determined or estimated for a random variable (and thus, for a corresponding vertex). The graph inference algorithm may undergo multiple iterations (thousands of iterations, for example), with each iteration providing estimates for all of the random number assignments. The estimates ideally improve with each iteration, and eventually, the estimated assignments converge. In this context, “convergence” of the assignments refers to the assignment estimation reaching a stable solution, such as (as examples) the probability of each assignment exceeding a threshold, the number of assignments that change between successive iterations falling below a threshold, and so forth. Given the large number of iterations and the relatively large number of vertices (thousands to billions of vertices, for example), it may be advantageous for the graph inference to be performed in a parallel processing manner by a multiple processor-based computing system.

One type of multiple processor-based computing system employs a non-uniform memory access (NUMA) architecture. In the NUMA architecture, processing nodes have local memories. In this context, a “processing node” (not to be confused with a node of a graph) is an entity that is constructed to perform arithmetic and logical operations, and in accordance with example implementations, a given processing node may execute machine executable instructions. More specifically, in accordance with example implementations, a given processing node may contain at least one central processing unit (CPU), which is constructed to decode and execute machine executable instructions and perform arithmetic and logical operations in response thereto. The “local memory” of a processing node refers to a memory that is located closer to the processing resources of the processing node in terms of interconnects, signal traces, distance and so forth, than other processing nodes, such that the processing node may access its local memory with less latency than other memories, which are external to the node and are called “remote memories” herein. Accesses by a given processing node to write data in and/or read data from a remote memory are referred to herein as “remote accesses” or “remote memory accesses.” The remote memories for a given processing node include memories shared with other processing nodes, as well as the local memories of other processing nodes. As a more specific example, a NUMA architecture computer system may be formed from multicore processor packages (multicore CPU packages, for example), or “sockets,” where each socket has its own local memory, which may be accessed by the processing cores of the socket. A socket is one example of a processing node, in accordance with some implementations.

One way to divide the task of performing graph inference is to partition the graph across all of the processing nodes such that each processing node estimates assignments for an assigned subset of the graph's vertices. However, the graph and its underlying data may not be a mutable data structure, which means that the vertices (and corresponding assignment determinations) may not be strictly partitioned among the processing nodes. In this manner, to estimate assignments for a given assigned subset of vertices, a given processing node may consider assignments for vertices that are not part of this subset. As a result, with a graph associated with a mutable data structure, the processing node may incur remote memory accesses to read the assignments for vertices outside of the assigned subset from a non-local memory (a memory that is local to another processing node, for example). For sparse graphs, a large portion of the execution time for performing graph inference may be attributed to remote and local memory accesses.

In accordance with example implementations that are described herein, for purposes of performing graph inference on a graph that contains multiple processing nodes, the inference processing is partitioned across the processing nodes. In this manner, each processing node is assigned a different partition of the graph for the inference processing and as a result, is assigned a set of vertices and corresponding edges of the graph. Each processing node also maintains a copy of a vertex table in its local memory. In accordance with example implementations, the local copy of the vertex table identifies all of the vertices of the graph (including the vertices that are not part of the assigned graph partition) and corresponding assignments for the vertices. Due to its local copy of the vertex table, a given processing node may determine and update the assignments for its assigned subset of vertices without incurring remote memory accesses. The assignments for vertices other than the assigned subset of vertices are determined by the other processing nodes. Although the assignments for these other vertices may be temporarily stale, or not current, in the local copy of the vertex table, these assignments allow the processing node to proceed with the graph inference while allowing the remote memory accesses that update these assignments to be performed in a more controlled, efficient manner.

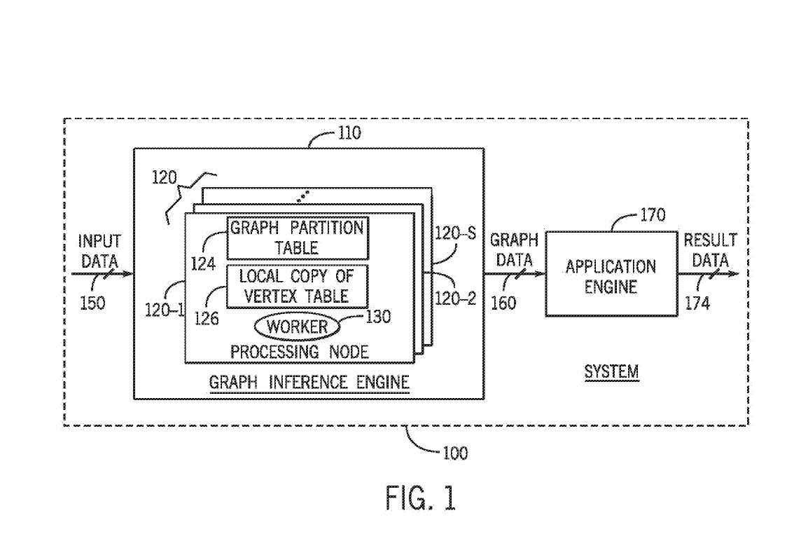

As a more specific example, FIG. 1 schematically depicts a system 100 in accordance with some implementations. The system 100 includes a graph inference engine 110 that receives input data 150. As an example, the graph inference engine 110 may be used to generate a graph (represented by graph data 160), which identifies malicious Internet domains, and the graph may be used by an application engine 170 to take action based on the graph. For example, the application engine 170 may be a firewall, a browser and so forth, which provides warnings or prevents access to identified malicious websites. It is noted that the graph inference engine 110 and application 170 may be used for many other purposes, such as malware detection, topic modeling, information extraction, and so forth. Thus, many implementations are contemplated, which are within the scope of the appended claims.

For the example implementation in which the graph inference engine 110 generates a graph to identify malicious domains, the graph, in general, may have vertices that are interconnected by edges. For this example implementation, a given vertex is associated with a web domain and has an associated random variable, and the random variable may have a binary state: a “1” value to indicate a non-malicious domain and a “0” state to indicate a malicious domain. The edges contain information about correlations between vertices connected by the edges. The input data 150 may represent direct observations about the vertices, i.e., some web domains are known to be malicious, and other domains are known not to be malicious. The input data 150 may further represent observed correlations between web domains.

In accordance with example implementations, the graph inference engine 110 is a multiple processing node machine. In this context, a “machine” refers to an actual, physical machine, which is formed from multiple central processing units (CPUs) or “processing cores,” and actual machine executable instructions, or “software.” A given processing core is a unit that is constructed to read and execute machine executable instructions. In accordance with example implementations, the graph inference engine 110 may contain one or multiple CPU semiconductor packages, where each package contains multiple processing cores (CPU cores, for example).

More specifically, in accordance with example implementations, the graph inference engine 110 includes S processing nodes 120 (processing nodes 120-1, 120-2 . . . 120-S, being depicted in FIG. 1). In accordance with example implementations, each processing node 120 contains processing cores and a local memory. The graph inference engine 110 uses the processing nodes 120 for purposes of executing a graph inference algorithm in a parallel fashion. In this processing, inevitably, the processing nodes 120 perform remote memory accesses, i.e., accesses to memories that are external or remote to the processing nodes 120. These remote memory accesses, in turn, incur significant amount of memory bandwidth, which in turn, adversely impacts the performance of the graph inference. For purposes of improving the performance, the graph inference engine 110 controls memory accesses to increase the number of local accesses, while efficiently controlling the remote memory accesses.

In accordance with example implementations, the graph inference processing is partitioned among the processing nodes 120. The “partitioning” of the graph refers to subdividing the vertices of the graph among the processing nodes 120 such that each node 120 is assigned the task of determining random number assignments for a different subset of vertices of the graph. The number of vertices per partition may be the same or may vary among the partitions, depending on the particular implementation. Moreover, the graph inference engine 110 may contain more than S processing nodes 120, in that one or multiple other processing nodes of the graph inference engine 110 may not be employed for purposes of executing the graph reference algorithm. The partitioning assignments may be determined by a user or may be determined by the graph inference engine 110, depending on the particular implementation. Each processing node 120 includes a worker engine (herein called a “worker 130”). As described further below, each worker 130 processes a partition of the graph by determining assignments for the vertices of the partitions in a series of iterations.

As depicted in FIG. 1, in accordance with example implementations, each processing node 120 (such as processing node 120-1) stores a graph partition table 124, which contains data that represents the partition of the graph, which is assigned to the node 120. In accordance with some implementations, the graph partition table 124 stores data identifying the vertices of the assigned graph partition, as well as data identifying the edges connecting these vertices.

As also depicted in FIG. 1, each processing node 120 further stores a local copy of a vertex table (hereinafter called the “vertex table copy 126”). In general, a complete vertex table (where “complete” refers to the table containing information for all of the vertices of the graph) is replicated on each of the processing nodes 120 and contains data identifying all of the vertices of the graph and the corresponding assignments for the random numbers of these vertices. Although the vertex table copy 126 stores the assignments for all of the vertices, the worker 130 of the processing node 120 updates the vertices for the vertices of the assigned graph partition as the assignments are determined by the worker 130. The updates are also communicated to the other processing nodes 120 for purposes of updating the other vertex table copies 126. As further described herein, the updates to the other vertex table copies 126 may be “push” type updates, in which each worker 130 writes its determined updates to the other, remote vertex table copies 126 or pull type updates in which each worker 130 reads the updates for vertex assignments outside of its assigned partition from the other processing nodes 120.

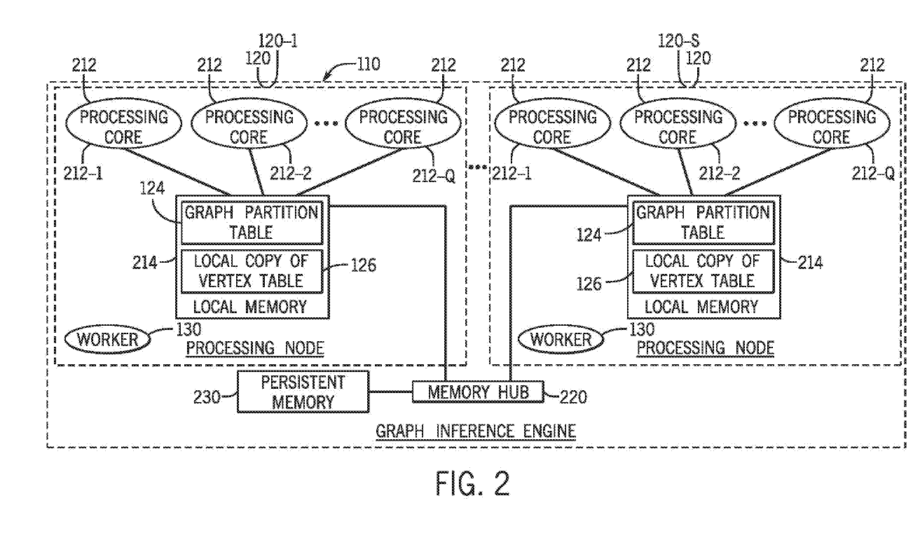

Referring to FIG. 2 in conjunction with FIG. 1, in accordance with a more specific example implementation, the graph inference engine 110 may employ a NUMA architecture, and each processing node 120 may be considered a “NUMA node.” In accordance with example implementations, the CPU package may be associated with a given socket of a physical machine, and as such, the local memory node 120 may also be referred to as a “socket.” As depicted in FIG. 2, each processing node 120 may contain Q CPU processing cores 212 (processing cores 212-1, 212-2 . . . 212-Q, being depicted in FIG. 2 for each node 120) and a local memory 214. The number of processing cores 212 per processing node 120 may vary or may be the same, depending on the particular implementations. As depicted in FIG. 2, the local memory 214 stores data, which represents the graph partition table 124 and data, which represents the vertex table copy 126.

The processing cores 212 experience relatively rapid access times to the local memory 214 of their processing node 120, as compared to, for example, the times to access a remote memory, such as the memory 214 of another processing node 120. In this manner, access to a memory 214 of another processing node 120 occurs through a memory hub 220 or other interconnect, which introduces memory access delays. In accordance with example implementations, each processing node 120 may contain a memory controller (not shown) to control bus signaling for a remote memory access. FIG. 2 also depicts a persistent memory 230 (a non-volatile memory, such as flash memory, for example), another remote memory, that may be accessed by the processing cores 120 via the memory hub 220.

In accordance with example implementations, the graph inference engine 110 executes a Gibbs sampling-based graph inference algorithm (also called “Gibbs sampling” herein). With Gibbs sampling, the worker 130 may determine an assignment (called “a”) for a given vertex by sampling the conditional probability distributions for the random variable to determine an instance (i.e., the assignment a) of the random variable. The conditional probability samples are based on the assignments for the neighboring vertices (or “neighbors”), and the edge information connecting the vertex to these neighbors.

The Gibbs sampling-based graph inference algorithm is performed in multiple iterations (hundreds, thousands or even more iterations), with a full sweep of the graph being made during each iteration to determine the assignments for all of the vertices. Due to the parallel processing, for each iteration, a given worker 130 determines assignments for all of the vertices of its assigned partition. To update a given vertex v, the worker 130 reads the current assignments of the neighbors of the vertex v, reads the corresponding edge information (for the edges connecting the vertex v to its neighbors), determines the assignment for the vertex v based on the sampled conditioned probability distributions and then updates the assignment for the vertex v accordingly.

In accordance with example implementations, the graph partition table 124 identifies the vertices of the assigned partition and the locations of the associated edge information. More specifically, in accordance with example implementations, the schema of the graph partition table 124 may be represented by “G<vᵢ,vₖ,f>,” where “vᵢ” and “vⱼ” represents two vertices on an edge in G; and “f” represents a pointer to information that is stored on the edge. In accordance with example implementations, data representing the edge information is also stored in the local memory 214.

In accordance with example implementations, the schema of the vertex table copy 126 is “V<vᵢ, a>,” where “vᵢ” represents a vertex identity, and “a” represents its assignment.

Thus, to update a given vertex assignment a for a vertex v in the vertex table copy 126, the worker 130 first reads from the graph partition table 124 the neighbors of a vertex v (including possibly assignment(s) of neighbors that are not part of the graph partitioned assigned to the worker 130), reads edge information for the corresponding edges based on the pointers from the graph partition table 124, reads the current assignments from the vertex table and then after determining the new assignment a, writes to the vertex table copy 126 to modify the copy 126 to reflect the updated assignments. In this context, “modifying” the vertex table copy 126 refers to overwriting assignments of the copy 126, which have changed, or been updated. Due to the storage of the vertex table local copy 126 on each local processing node 120, the memory accesses are controlled so that the above-described memory accesses are local. In other words, the threads executing on the processing node 120, such as the threads executing the worker 130, access memory associated with the local processing node 120 for purposes of determining the assignments for the vertices of the assigned partition. Because the vertex table is replicated on all of the local memory nodes 120, in accordance with example implementations, operations involving updating the vertex assignments involve local reads. The updates to other processing nodes 120 remote memory operations, as further described below.

There are two ways to update remote vertex table copies 126 when the copies appear on all of the processing nodes 120. In the first way, the worker 130 may push updates to the other processing nodes 120. For push updates, a worker 130 that updates an assignment may push, or write, the corresponding update to the vertex table copies 126 that are stored on the other processing nodes 120. For pull updates, the worker 130 pulls, or reads, any vertex assignment updates from the vertex table copies 126 shared on the other processing nodes 120.

A potential advantage of the push update strategy is if there is no update, there is no need to push the updates, and hence, no memory accesses are incurred. This may be particularly useful for iterative graph inference algorithms, such as the Gibbs sampling inference algorithm, as it is often the case that the vertex assignments converge as the algorithm proceeds. Although the push strategy incurs remote writes, the updates may be queued, or accumulated, so that multiple updates may be written at one time, thereby more effectively controlling memory bandwidth communication. Which of the two strategies, push or pull, achieves a better performance may depend on such factors as how soon the graph converges and the remote read and write bandwidth ratios.

Regardless of whether push or pull updates are used, the batch size that is associated with these updates may be varied, depending on the particular implementation. In this context, the “batch size” generally refers to the size of the update data, such as a number of updates accumulated before the updates are pushed/pulled to/from a remote processing node 120. In this manner, in accordance with some implementations, on one extreme, a push/pull update may occur on a given processing node after each vertex is updated. On the other extreme, the push/pull update may occur at the end of a particular iteration of the Gibbs sampling graph inference algorithm or even after several iterations to push or pull the updates to the other copies of the vertex table.

An advantage of a relatively small batch size is that the copy of the vertex table is refreshed more frequently, which may lead to relatively fewer iterations for convergence. A potential advantage of a relatively larger batch size is that memory bandwidth may be used more efficiently, which may lead to better throughput (or less time to complete one iteration).

Thus, the batch sizes may be a function of the following: 1.) how soon the graph converges; and 2.) the memory bandwidth. The tradeoffs between batch size and push and pull updates are summarized below:

TABLE 1

| Small Batch Size | | Large Batch Size | |
|---|---|---|---|
| Push | Pull | Push | Pull |
| Hard to | Hard to | Easy to | Easy to |
| converge | converge | converge | converge |
| graphs; remote | graphs; remote | graphs; and | graphs; and |
| writes have | reads have | remote writes | remote reads have |
| higher averaged | higher averaged | have higher | higher averaged |
| throughput than | throughput than | averaged | throughput than |
| remote reads | remote writes | throughput than | remote writes |
| | | remote reads | |

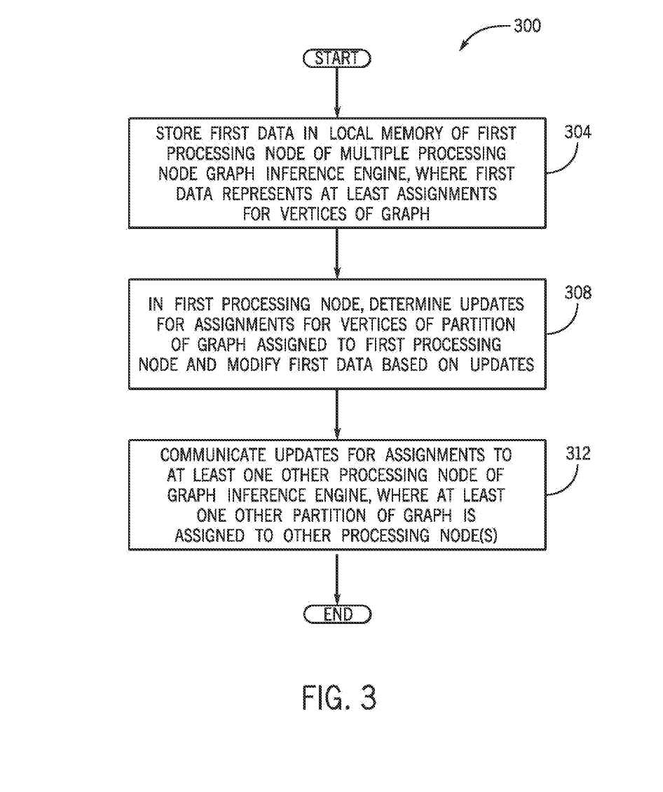

Thus, referring to FIG. 3, in accordance with example implementations, a technique 300 to perform graph inference on a multiple processing node graph inference engine includes storing (block 304) first data in a local memory of the first processing node, where the first data represents at least assignments for vertices of the graph. The technique 300 includes, in the first processing node, determining (block 308) updates for assignments for vertices of a partition of the graph, which is assigned to the first processing node and modifying the first data based on the updates. Pursuant to the technique 300, the updates for the assignments are communicated (block 312) to at least one other processing node of the graph inference engine, and at least one other partition of the graph is assigned to the other processing node(s).

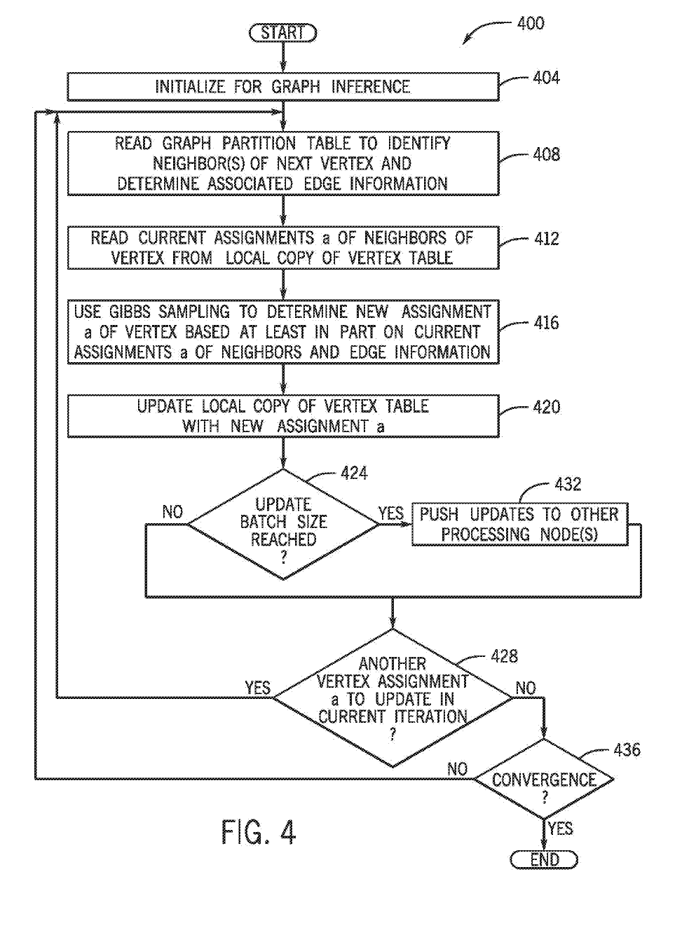

Referring to FIG. 4, in accordance with example implementations, the worker 130 may perform a technique 400 for purposes of updating vertices assigned to the associated processing node. Pursuant to the technique 400, the worker 130 initializes (block 404) for the graph inference (resets loop parameters, assigns initial random assignments to vertices for the first iteration, and so forth) and reads (block 408) the local graph partition table for purposes of identifying one or multiple neighbors of the first vertex to be processed in the next iteration.

The next iteration then begins by the worker 130 reading (block 412) the current assignments a of neighbors of the vertex from the vertex table copy 126. Next, the worker 130 determines (block 416) the new assignment a of the vertex based at least in part on the assignments a of the neighbors.

Using the new assignment, the worker 130 updates (block 420) the local copy of the vertex table. The worker 130 accumulates, however, the updates for the other processing nodes (i.e., the updates for the vertex table copies 126 stored in local memories of the other processing nodes). In this manner, the worker 130 determines (decision block 424) whether the accumulated updates for the other processing nodes have reached a predefined update batch size threshold. In this manner, the “batch size threshold” for this example refers to the number of vertice updates that the worker 130 accumulates before the updates are communicated to the other (remote) processing nodes. For example, if the batch size is three, the worker 130 accumulates the updates until the number of updates equals three and then pushes new updated values for three vertices to the remote processing nodes at one time. Therefore, if, pursuant to decision block 424, the worker 130 determines that the batch size has been reached, then the worker 130 pushes (block 432) the accumulated updates to the other processor node(s), in accordance with example implementations. The worker 130 then determines (decision block 428) whether another vertex assignment a to update is in the current iteration. In other words, the worker 130 determines whether any more vertices remain to be processed in the current iteration, and if so, control returns to block 408. Otherwise, the iteration is complete, and assignments for all of the vertices for the most recent iteration have been determined.

Next, the worker 130 determines (decision block 436) whether convergence has occurred and if not, control returns to block 408. As described above, convergence generally occurs when the assignments are deemed to be stable and may involve communications among the processing node as convergence may be globally determined for the graph inference. In accordance with further example implementations, a given processing node may determine whether the assignments for its assigned partition have converged independently from the convergence of any other partition. Regardless of how convergence is determined, after a determination that convergence occurs (decision block 436), the graph inference algorithm is complete.

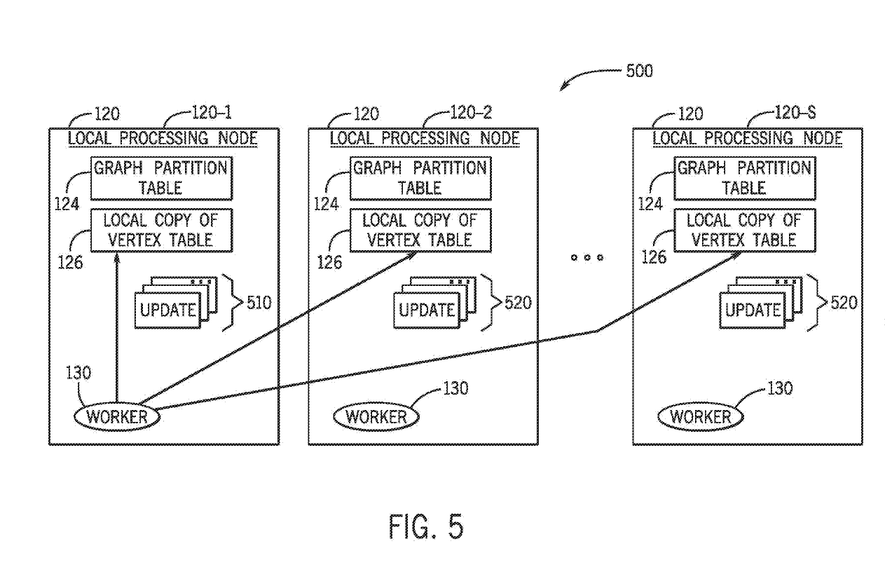

FIG. 5 is an illustration 500 depicting how a worker of a given local memory node 120-1 updates the vertex table copies 126, in accordance with example implementations. As depicted in FIG. 5, the worker 130 of the local memory node 120-1 writes local updates 510 to its local copy 126 and accumulates these updates. When the batch size is exceeded, the worker 130 then writes remote updates 520 to the other copies 126 stored on the other processing nodes 120.

In accordance with example implementations, the worker 130 may be formed from machine executable instructions that are executed by one or more of the processor cores 212 (see FIG. 2) of the processing node 120. As such, the worker 130 may be a software component, i.e., a component that is formed by at least one processor/processor core executing machine executable instructions, or software. Thus, in accordance with example implementations, the worker 130 is one example of instructions that are stored in a non-transitory computer readable storage medium that when executed by at least one processor core associated with a processing node cause the processor core(s) to read a graph partition table from a local memory of the processing node(s), where the graph partition table describes a partition of the graph assigned to the processing node; read a local copy of a vertex table from the local memory, where the local copy of the vertex table describes vertices of the graph; perform graph inference to update assignments of the vertices assigned to the processing node; write the updated assignments to the local copy of the vertex table; and write the updated assignments to a copy of the vertex table stored in a local memory of at least the processing node(s).

In accordance with further example implementations, the worker 130 may be constructed as a hardware component that is formed from dedicated hardware (one or more integrated circuits that contain logic that is configured to perform a graph inference algorithm). Thus, the worker 130 may take on one or many different forms and may be based on software and/or hardware, depending on the particular implementation.

Other implementations are contemplated, which are within the scope of the appended claims. For example, in accordance with further example implementations, the graph inference engine 110 (see FIG. 1) may execute a graph inference algorithm other than a Gibbs sampling-based algorithm, such as a belief propagation algorithm, a variable elimination algorithm, a page rank algorithm, and so forth.

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. A method comprising:
performing graph inference in a graph inference engine comprising multiple processing nodes to determine assignments for vertices of a graph, wherein performing the graph inference comprises controlling remote memory accesses within the engine comprising:
storing first data in a local memory of the first processing node, the first data representing at least assignments for a plurality of vertices of the graph;
in the first processing node, determining updates for the assignments for a subset of the plurality of vertices of a partition of the graph assigned to the first processing node and modifying the first data based on the updates; and
communicating the updates to at least one other processing node of the multiple processing nodes, at least one other partition of the graph being assigned to the at least one other processing node.

2. The method of claim 1, wherein communicating the updates comprises pushing the updates to at least one other processing node or pulling the updates from at least one other processing node.

3. The method of claim 1, further comprising accumulating the updates in the first processing node, wherein communicating the updates comprises selectively pushing the updates based at least in part on a size associated with the accumulated updates.

4. The method of claim 1, wherein
performing the graph inference comprises performing the graph inference for multiple iterations;
the assignments for all of the vertices of the assigned partition being determined in each iteration; and
communicating the updates comprises accumulating the updates and communicating the accumulated updates.

5. The method of claim 1, wherein performing the graph inference comprises executing a Gibbs sampling-based graph inference algorithm.

6. A system comprising:
a plurality of sockets, wherein each socket is associated a plurality of processor cores and a local memory; and
wherein at least one socket of the sockets comprises an engine to:
perform graph inference on a partition of a graph, the partition being associated with a subset of a plurality of vertices of the graph;
update a first table stored in the local memory of the socket based on the graph inference performed on the partition, the first table describing the plurality of vertices and assignments for the vertices; and
update a table stored in at least one other local memory of at least one other socket of the plurality of sockets based on the graph inference performed on the partition.

7. The system of claim 6, wherein the engine:
determines assignments for the vertices of the subset of vertices based at least in part on at least one assignment for a vertex which is a neighbor of the subset and is determined by another socket; and
updates the first table based on the assignments determined by the engine.

8. The system of claim 6, wherein the first table is associated with schema describing vertices assigned to the partition and assignments associated with the vertices assigned to the partition.

9. The system of claim 6, wherein the engine further accesses the local memory to associate a graph partition table stored in the memory, wherein the graph partition table is associated with schema, and the schema associated with the graph partition table describes vertices associated with edges and pointers to information about the edges.

10. An article comprising a non-transitory computer readable storage medium to store instructions that when executed by at least one processor core associated with a processing node cause the at least one processor core to:
read a graph partition table from a local memory of the processing node, the graph partition table describing a partition of the graph assigned to the processing node;
read a local copy of a vertex table from the local memory, the local copy of the vertex table describing vertices of the graph;
perform graph inference to update assignments of vertices contained with the partition of the graph assigned to the processing node;
write the updated assignments to the local copy of the vertex table; and
write the updated assignments to a copy of the vertex table stored in a local memory of at least one other processing node.

11. The article of claim 10, the storage medium storing instructions that when executed by the at least one processor core cause the at least one processor core to:
accumulate the updates of the assignments;
compare a number of the accumulated updates to a threshold; and
write the updated assignments to the copy of the vertex table stored in the at least one other processing node in response to a comparison of the number to a predetermined threshold.

12. The article of claim 10, the storage medium storing instructions that when executed by the at least one processor core cause the at least one processor core to:
perform multiple iterations of the graph inference, wherein each iteration is associated with processing of all of the vertices assigned to the graph partition; and
regulate the number of the iterations based at least in part on a determined convergence of the graph inference.

13. The article of claim 10, the storage medium storing instructions that when executed by the at least one processor core cause the at least one processor core to perform Gibbs sampling-based graph inference, page rank-based graph inference, belief propagation-based graph inference or variable elimination-based graph inference.

14. The article of claim 10, the storage medium storing instructions that when executed by the at least one processor core cause the at least one processor core to push the updates to the at least one other processing node.

15. The article of claim 10, wherein the storage medium storing instructions that when executed by the at least one processor core cause the at least one processor core to update assignments for the vertices contained in the partition assigned to the processing node based at least in part on assignments of neighbors of the vertices.
